(19) United States
(12) Patent Application Publication
(10) Pub. No.: US 2026/0257486 A1
(43) Pub. Date: Sep. 3, 2026

(54) LIQUID STORAGE CONTAINER, MANUFACTURING METHOD OF LIQUID STORAGE CONTAINER, AND LIQUID EJECTION APPARATUS

(71) Applicant: CANON KABUSHIKI KAISHA, Tokyo (JP)

(72) Inventors: MASATOMO OJIMA, Saitama (JP); MAKOTO WATANABE, Kanagawa (JP); JUNICHIRO IRI, Kanagawa (JP)

(21) Appl. No.: 19/544,793

(22) Filed: Feb. 19, 2026

(30) Foreign Application Priority Data
Feb. 20, 2025 (JP) 2025-025885

(51) Int. Cl. B41J 2/175

(52) U.S. Cl. CPC B41J 2/17596; B41J 2/17513; B41J 2/17553; B41J 2/17559; B41J 2002/17516

(57) ABSTRACT

A liquid storage container includes a liquid storage part having a first face and a second face and a liquid supply unit part including a liquid suction part and a liquid supply part. The liquid supply part has first and second slopes on the first surface and third and fourth slopes on the second face, and at least one of angle formed by the first and third slopes and an angle formed by the second and fourth slopes is an angle A, the liquid suction part has fifth and sixth slopes on the side of the first face and seventh and eighth slopes on the second face, and at least one of an angle formed by the fifth and seventh slopes and an angle formed by the sixth and eighth slopes is an angle B, and an angle ratio B/A is 0.8 to 1.1.

### BACKGROUND

### Field of the Technology

The present disclosure relates to a liquid storage container, a manufacturing method of the liquid storage container, and a liquid ejection apparatus including the liquid storage container.

### Description of the related Art

There have been known liquid storage containers (e.g., ink packs) in which liquid (in particular, ink) to be supplied to a liquid ejection apparatus, such as an inkjet printer, is stored in a flexible liquid storage part.

For example, Japanese Patent Laid-Open No. 2018-65373 (Patent Literature 1) describes a flexible liquid (in particular, ink) storage body. The liquid storage body in Patent Literature 1 has a liquid lead-out member attached to one end of a liquid storage part. Then, the liquid storage body has an ink lead-out pipe connected to an end of a spacer member extending toward the other end of the liquid storage part. Further, ink is led out from the deep region in the liquid storage part to the ink lead-out member through a lead-out port of this ink lead-out pipe located at the center of the liquid storage part. According to Patent Literature 1, the spacer member prevents movement of the position of the end of the ink lead-out pipe. Further, as the liquid is consumed, the liquid storage part more easily contracts from the contact portion with the spacer member along the inclined surface shape of the spacer member, and thus the blockage of the flow path of liquid is more effectively prevented.

Containers using plastic such as liquid storage containers are requested to reduce the amount of plastic used for the liquid storage containers from the perspective of environmental considerations. In such requests, the ease of using up the liquid in the liquid storage container may deteriorate depending on the configuration of the liquid storage container. Further, depending on the liquid supply member used in the liquid storage container, attaching it to the storage container may distort the attachment portion and cause wrinkles.

### SUMMARY

The present disclosure provides a liquid storage container that can prevent deterioration in the ease of using up the liquid and prevent welding wrinkles during the above welding in the liquid storage container. Further, the present disclosure provides a manufacturing method of the liquid storage container and a liquid ejection apparatus including the liquid storage container.

A liquid storage container according to some embodiments of the present disclosure includes a liquid storage part that stores liquid and a liquid supply unit part that is attached to the liquid storage part, wherein the liquid storage part has a first face and a second face, the liquid supply unit part has a liquid suction part and a liquid supply part, the liquid supply part has a first slope and a second slope inclined in opposite directions to each other on a side of the first face and a third slope and a fourth slope inclined in opposite directions to each other on a side of the second face, and at least one of an angle formed by the first slope and the third slope and an angle formed by the second slope and the fourth slope is an angle A, the liquid suction part has a fifth slope and a sixth slope inclined in opposite directions to each other on the side of the first face and a seventh slope and an eighth slope inclined in opposite directions to each other on the side of the second face, and at least one of an angle formed by the fifth slope and the seventh slope and an angle formed by the sixth slope and the eighth slope is an angle B, and an angle ratio (B/A) of the angle B to the angle A is greater than or equal to 0.8 and less than or equal to 1.1.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram showing an example of a liquid storage container of the present disclosure, and is a plan view of the liquid storage container.

FIG. 1B is a diagram showing an example of the liquid storage container of the present disclosure, and is a cross-sectional view taken along IB-IB in FIG. 1A.

FIG. 1C is a diagram showing an example of the liquid storage container of the present disclosure, and is a diagram of the liquid storage container in FIG. 1A if the liquid storage container is viewed from the side of a liquid supply unit part.

FIG. 2 is an exploded perspective view of the liquid storage container of the present disclosure.

FIG. 3A is a plan view showing the liquid supply unit part.

FIG. 3B is a cross-sectional view of a liquid supply part where the liquid supply unit part in FIG. 3A is cut along IIIB-IIIB and viewed toward the direction of a liquid suction part.

FIGS. 4A and 4B are diagrams showing different configuration examples of a bonding part of the liquid supply part.

FIG. 5A is a perspective view showing the liquid suction part of the liquid supply unit part.

FIG. 5B is a diagram of the liquid suction part in FIG. 5A viewed from the side on which it is connected to the liquid supply part.

FIGS. 6A to 6C are diagrams showing different configuration examples of the liquid suction part with viewed from the side of a connection part.

FIG. 7 is a schematic cross-sectional view of the liquid supply unit part in the state of being attached to a liquid storage part.

FIG. 8 is a plan view of the liquid storage part before the liquid supply unit part is attached.

FIG. 9 is a perspective view showing an example of a liquid ejection apparatus.

FIG. 10 is a flowchart showing a manufacturing method of the liquid storage container.

FIGS. 11A to 11C are schematic diagrams showing an example of operation of a first welding step in welding the liquid supply unit part and the liquid storage part together.

FIG. 12A is a schematic diagram showing an example of a welding horn, and is a top view of a first welding horn.

FIG. 12B is a schematic diagram showing an example of a welding horn, and is a top view of a second welding horn.

FIG. 12C is a schematic diagram showing an example of a welding horn, and is a top view of a third welding horn.

FIG. 13 is a diagram for describing a welding step in manufacturing the liquid storage container of the present disclosure.

### DESCRIPTION OF THE EMBODIMENTS

Containers using plastic such as liquid storage containers are requested to reduce the amount of plastic used for the liquid storage containers from the perspective of environmental considerations.

As one approach, the inventors examined a liquid storage container that does not have a configuration in which a spacer member is provided to locate a suction port of a liquid lead-out pipe at the center of a liquid storage part, as in known configurations (e.g., Patent Literature 1). That is, the inventors examined a configuration in which the liquid suction port is provided near an end of the liquid storage part, for example, a configuration such that liquid is supplied to the outside from one end of the liquid supply part provided in the liquid storage part (the end facing the inside of the liquid storage part).

However, the inventors found that such a configuration of the liquid storage container creates new and additional problems. Specifically, as the liquid in the liquid storage container is consumed, the liquid storage part contracts. At this time, any height difference between the shapes of the liquid supply part and the liquid storage part increases uncontracted space in the liquid storage part, which can deteriorate the ease of using up the liquid. Further, any height difference between the liquid supply part and the liquid suction part due to their shapes may cause a problem such as distortion in the opening of the liquid storage part in the case where the liquid storage part is welded to the liquid supply unit part, causing welding wrinkles in the welding portion.

Accordingly, the present disclosure provides a liquid storage container that, in the case where the liquid in the liquid storage part is consumed or it is deaerated, reduces uncontracted space around the liquid lead-out part and prevents welding wrinkles in the liquid storage part due to welding. Further, the present disclosure provides a manufacturing method of the liquid storage container and a liquid ejection apparatus using the liquid storage container.

As described above, the inventors found a problem that employing a configuration in which a liquid suction port is provided near an end of a flexible liquid storage part from the perspective of reducing the amount of plastic used in a liquid storage container creates much uncontracted space in the liquid storage container. Further, the inventors found a problem that troubles may occur such as occurrence of welding wrinkles in the case where the liquid storage part and the liquid supply unit part are welded together due to the influence of a height difference between the liquid storage part and the liquid suction part. To solve these problems, the inventors examined the shapes and arrangement of the liquid supply part and the liquid suction part of the liquid supply unit part in more detail, and have come to the configuration in the present disclosure.

The following will specifically describe embodiments of a liquid storage container (e.g., an ink pack or an ink cartridge), a manufacturing method of the liquid storage container, and a liquid ejection apparatus including the liquid storage container according to the present disclosure with reference to the drawings. Note that the following embodiments are examples suitable for implementing the present disclosure, and the present disclosure is not limited to these configurations. Further, the contents described in the embodiments can be combined partially.

The description in this specification may define directions using the X, Y, and Z axes for the liquid storage container of the present disclosure. These axes are indicated by the directional axes with arrows shown in the drawings. For each axis, if the axial direction is indicated by a double-headed arrow, this indicates that the object moves in both the "+" and "-" directions of that axis.

In the case where the direction of each axis is specified in this specification, the direction pointed by the arrow on the axis in the X, Y, or Z direction is defined as the "+" direction of each axis. In other words, for the "+" or "-" direction on each axis, the "+" direction is the direction pointed by the arrow, and the "-" direction is the opposite direction of the direction pointed by the arrow. Further, in the case where the direction of an axis is referred to without specifying the "+" or "-" direction, it is simply referred to as "X-axis direction", "Y-axis direction", or "Z-axis direction".

Further, in this specification, the height direction of the liquid storage container (i.e., the gravity direction) is set to the Z-axis direction. The side to which the gravity in the Z-axis direction (gravity direction) is applied (also referred to as the gravity side or the lower side in this specification) is set to the +Z direction, and the opposite side of the side to which the gravity in the Z-axis direction (gravity direction) is applied (also referred to as the antigravity side or the upper side in this specification) is set to the -Z direction.

In this specification, "liquid" includes any liquid that can be used for image formation, printing, processing of a recording medium, or the like by being applied to a recording medium. Therefore, "liquid" in this specification is a concept that encompasses any liquid that can be used for recording, printing, or processing. Further, the concept of recording is also not particularly limited but can be applied to industrial applications and the like. For example, it can be used for applications such as fabrication of biochips, printing of electronic circuits, and fabrication of semiconductor substrates.

The terms "liquid" and "ink" are used in this specification. These terms are used in the present disclosure as a concept that encompasses any liquid that can be used for recording. Further, "liquid" and "ink" refer to any liquid medium that can be used for image formation, printing, processing of a recording medium, or the like by being applied to a recording medium. Accordingly, the terms "liquid" and "ink" are used in this specification as having an interchangeable meaning.

In this specification, "flexibility" or "flexible" means being soft and bendable, or having such properties.

### I. Liquid Storage Container

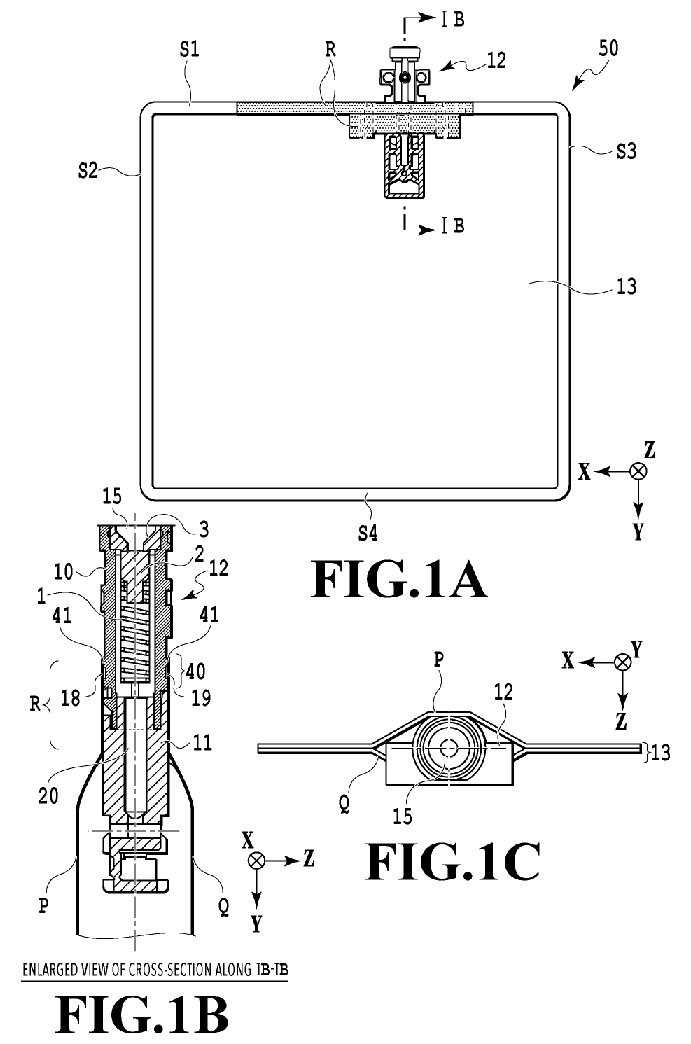

A liquid storage container 50 according to a first embodiment of the present disclosure will be described with reference to FIG. 1. FIG. 1A is a plan view of an embodiment of the liquid storage container of the present disclosure. FIG. 1B is an enlarged cross-sectional view of a liquid supply unit part 12 of the liquid storage container (an enlarged view of the cross-section along IB-IB in FIG. 1A). FIG. 1C is a schematic diagram of the liquid storage container 50 viewed from the side of the liquid supply unit part 12 (viewed from the -Y direction).

The liquid storage container 50 of the present disclosure has a flexible liquid storage part 13 and the liquid supply unit part 12 as shown in FIG. 1A. The liquid storage part 13 is configured to be able to store therein liquid such as ink. The liquid supply unit part 12 is for supplying the liquid stored in the liquid storage part 13 to the outside.

The liquid supply unit part 12 is disposed on one side of the liquid storage part 13 and is bonded to the liquid storage part 13 by appropriate means such as welding.

In the liquid storage container 50, if the bondability (e.g., thermal weldability) between constituent elements is taken into account, the liquid storage part 13 and the liquid supply unit part 12 can use the same material at least in the bonding surface.

The following will describe the liquid storage part 13 and the liquid supply unit part 12 using FIGS. 1A to 8.

### 1. Liquid Storage Part

In the present disclosure, the liquid storage part 13 is flexible and is configured to be able to store liquid (e.g., ink) therein. The liquid storage part 13 may have any known structure and shape as long as it can store liquid. Specifically, it may be of a pillow type formed by rolling up a film into a tube and closing the top and bottom of the tube, a three-sided seal type formed by putting two films on top of each other and joining their edges together, a four-sided seal type, and the like, or a gusset type. Further, known methods can also be used as methods of manufacturing liquid storage parts in such shapes.

A specific configuration of the liquid storage part 13 of the liquid storage container 50, which is an embodiment of the present disclosure, will be described using FIGS. 1A to 1C.

In the present embodiment, the liquid storage part 13 may have a rectangular shape, such as an oblong shape, as shown in FIG. 1A. In the present embodiment, it may have quadrangular shapes other than an oblong shape, such as a trapezoidal or square shape. Alternatively, it may have a polygonal shape, such as a triangular, quadrangular, or pentagonal shape. Further, it may have a shape like a polygonal shape with rounded corners.

In the present embodiment, the liquid storage part 13 has at least a first face (P) and a second face (Q) opposite to the first face as shown in FIGS. 1B and 1C. The first face (P) and the second face (Q) have the four sides (S1, S2, S3, and S4) of the liquid storage part 13, and are joined together on these four sides. The joining can be done using a known joining method such as welding. Among the above four sides, the sides S2 and side S3, which form the side faces of the liquid storage part 13, may be directly joined together, or joined in the form of being connected together via a gusset surface.

Furthermore, the liquid storage part 13 has the side S1, which is provided with the liquid supply unit part 12 described later, among the above four sides. In the present embodiment, the side S1 is also referred to as a first side. In the present embodiment, the first face (P) and the second face (Q) are joined together with the liquid supply unit part 12 on the common first side (side S1). Further, the liquid storage part 13 has the sides S2 and S3 opposite to each other on its side faces (in the X-axis direction in FIGS. 1A to 1C), and has the side S4 opposite to the above side S1. It has a region R (seal portion) shown in FIG. 1A on a portion of the above side S1 and around the portion, and the region R (seal portion) is provided with the liquid supply unit part 12, which is put in the liquid storage part 13 and is for supplying liquid to the outside. Note that in this specification, the region R is also referred to as the seal portion.

Any known material may be used as the material used for the liquid storage part 13 as long as it can store liquid therein and has flexibility. Specifically, examples thereof include resin films such as polyester like polyethylene terephthalate (PET), polyamide (PA), and polyolefin such as polyethylene (PE) and polypropylene (PP). Further, the film as the material of the liquid storage part 13 is a film containing resin described above, and may be a film with a single-layer structure or a laminated structure including a plurality of layers. Further, these resin films may be configured to include a coating film or a vapor deposition film in order to impart gas barrier property or moisture barrier property to the film. Furthermore, as the film constituting the liquid storage part 13, it is also possible to laminate paper or aluminum foil on a resin film. For the purpose of storing liquid, in one embodiment, a material that can suppress the evaporation of moisture in the liquid can be used. In particular, a film using aluminum foil can be used. Further, in one embodiment, the film thickness of the film used for the liquid storage part 13 can be 100 μm or more and 220 μm or less.

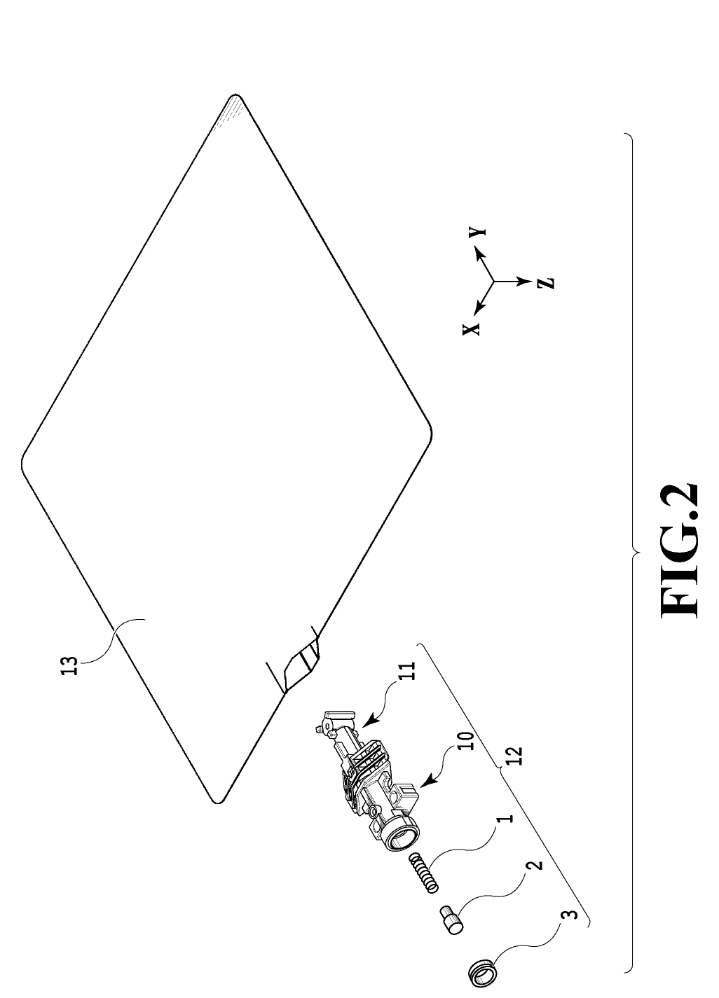

As shown in FIGS. 1B and 1C, the liquid storage part 13 is joined to the liquid supply unit part 12 described later in the region R (seal portion). The liquid storage part 13 may be joined to the liquid supply unit part 12 in the region R (seal portion) on the side S1 over a partial region of a liquid supply part 10 and a liquid suction part 11 of the liquid supply unit part 12. As shown in FIGS. 1B, 1C and FIG. 2, the liquid supply unit part 12 have the liquid supply part 10 disposed to face the outside of the liquid storage part 13 (so that a liquid supply port 15 of the liquid supply part 10 faces the outside of the liquid storage part 13) and the liquid suction part 11 disposed inside the liquid storage part 13. Here, in the present embodiment, the portion to be bonded to the liquid storage part 13 in the liquid supply part 10 is a bonding part 40, which will be described later as a specific example, and the portion located outside the liquid storage container is the portion excluding the bonding part 40 in the liquid supply part.

### 2. Liquid Supply Unit Part

The liquid supply unit part 12 of the liquid storage container 50 of the present disclosure will be described with reference to FIGS. 2 to 4B.

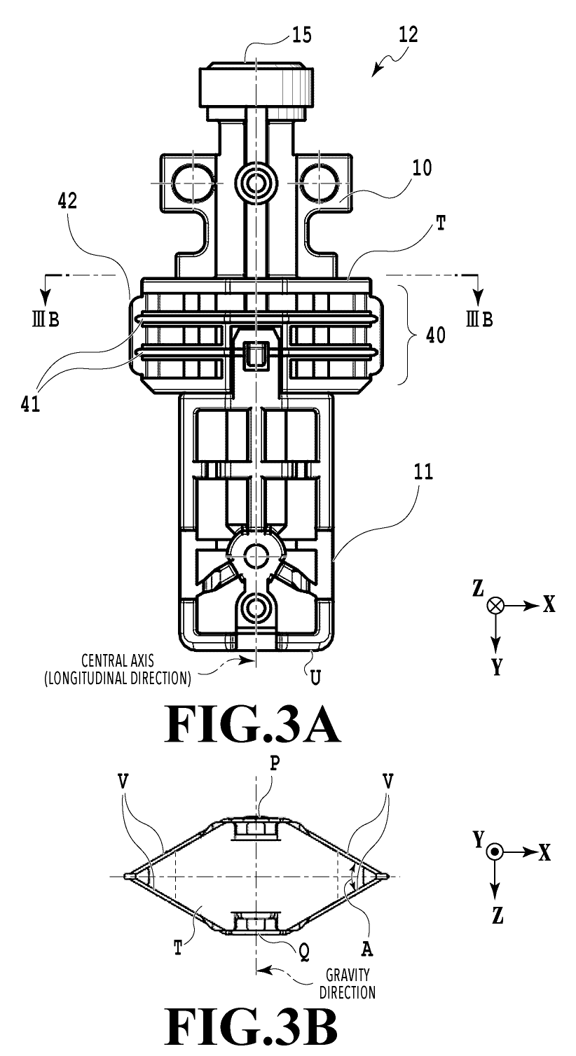

FIG. 2 is a perspective view of the liquid storage container 50 of the present embodiment, and FIG. 3A is a plan view of the liquid supply unit part 12 in the present embodiment. Further, FIG. 3B is a cross-sectional view taken along the IIIB-IIIB line in FIG. 3A (a diagram viewed from the +Y direction).

The liquid supply unit part 12 includes the liquid supply part 10 and the liquid suction part 11 as shown in FIGS. 2 and 3A.

In the present embodiment, as shown in FIG. 3A, the liquid supply part 10 and the liquid suction part 11 are connected together along the Y-axis direction of the liquid supply unit part 12. As shown in FIG. 3A, this Y-axis direction is a direction along the longitudinal direction of the liquid supply unit part 12. In this specification, the axis along this Y-axis direction (the longitudinal direction of the liquid supply unit part 12) is referred to as "the central axis of the liquid supply unit part 12" (also simply referred to as "the central axis" in this specification). Further, the direction of the central axis (the Y-axis direction or the longitudinal direction) is referred to as "the central axis direction" of the liquid supply unit part. The central axis direction of the liquid supply unit part 12 (the longitudinal direction of the liquid supply unit part 12) is a direction orthogonal to the gravity direction (Z-axis direction) defined earlier. Further, the plane (X-Y plane) including the above central axis and perpendicular to the gravity direction is referred to as "the central axis plane". Furthermore, the plane orthogonal to the central axis plane is referred to as the gravity direction plane (Y-Z plane).

In the present disclosure, the liquid supply unit part 12 may have any structure and shape as long as it is configured to supply the liquid stored in the liquid storage part 13 to the outside. However, the liquid supply unit part 12 can include the liquid supply part 10 and the liquid suction part 11 described below. In the present disclosure, for the purpose of reducing the amount of plastic used in the liquid storage container 50, the liquid supply unit part 12 is provided in the region R (seal portion) of the liquid storage part 13, as described above.

As shown in FIGS. 2 to 6C, the liquid supply unit part 12 of the present embodiment includes the liquid supply part 10 and the liquid suction part 11, which are detachable from each other. However, in the liquid supply unit part 12 of the present disclosure, the liquid supply part 10 and the liquid suction part 11 may be formed integrally.

In the liquid storage container 50 of the present disclosure, the liquid supply unit part 12 has the liquid supply part 10 disposed to face the outside of the liquid storage part 13 (so that the liquid supply port 15 of the liquid supply part 10 faces the outside of the liquid storage part 13), and the liquid suction part 11 disposed inside the liquid storage part 13.

The liquid supply unit part 12 shown in FIGS. 3A and 3B is configured to be able to supply liquid, if the liquid supply unit part 12 is connected to a liquid delivery unit 106 provided in a liquid ejection apparatus 100 described later. For this reason, it can be provided on one side of the liquid storage part of the liquid storage container 50 (specifically, the side S1 having the region R (seal portion) shown in FIG. 1A).

Next, the liquid supply part 10 and the liquid suction part 11, which are constituent elements of the liquid supply unit part 12, will be described.

The liquid supply part 10 is sandwiched between the first face (P) and the second face (Q) in the region R (seal portion) as described above and as shown in FIG. 1A, and has the bonding part 40 having a first portion T as shown in FIG. 3A. Further, as shown in FIG. 3A, the liquid suction part 11 of the liquid supply unit part 12 has a second portion U, which is the terminal end of the liquid suction part 11. The second portion U is located inside the liquid storage part 13, and is an end located in the +Y direction of the liquid storage part 13 from the above first portion T. The first portion T has two slopes (V) sandwiched between the first face (P) and the second face (Q), as shown in FIG. 3B. These slopes (V) are two slopes (V): a slope including a first slope and a second slope (on the side of the first face (P)) and a slope including a third slope and a fourth slope (on the side of the second face (Q)). Specifically, as shown in FIG. 3B, the two slopes (V) are two slopes (V): a slope (the first slope and the second slope) inclined in opposite directions to each other on the side of the first face (P) and a slope (the third slope and the fourth slope) inclined in opposite directions to each other on the side of the second face (Q). In the liquid supply part 10 of the present embodiment, at least one of the angle formed by the first slope and the third slope and the angle formed by the second slope and the fourth slope is an angle A. In the present embodiment, the angle formed by the first slope and the third slope can be the angle A and the angle formed by the second slope and the fourth slope can be also the angle A. Note that in the present embodiment, the slope on the first face side including the first slope and the second slope and the slope on the second face side including the third slope and the fourth slope can be symmetrical to each other with respect to the plane perpendicular to the gravity direction (the X-Y plane or the central axis plane), as shown in FIG. 3B.

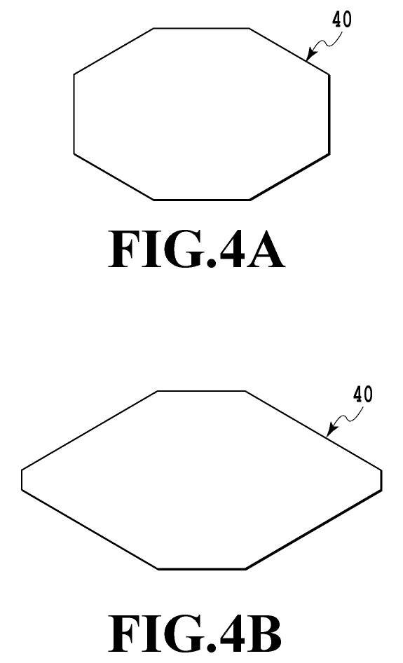

FIGS. 4A and 4B show different examples of the shape of the first portion T of the liquid supply part 10 (the shape formed of the above two slopes (V)). The shape of the first portion T is the shape viewed from the side face (Y-axis direction) of the bonding part 40 described later, and both ends thereof (in the X-axis direction) may have chamfered shapes (FIG. 4A) or sharp shapes (FIG. 4B).

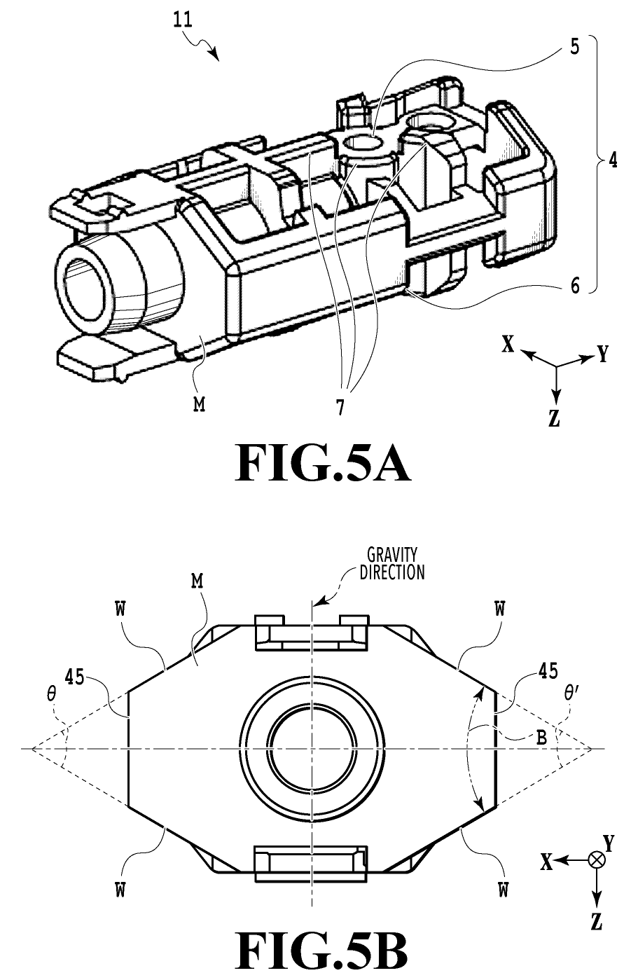

The liquid suction part 11 will be described with reference to FIGS. 5A and 5B. FIG. 5A is a perspective view of the liquid suction part 11, and FIG. 5B is a diagram of the liquid suction part 11 viewed from a surface (connection surface (M)) to be connected to the liquid supply part 10. As shown in FIG. 5A, the liquid suction part 11 is only required to be configured to lead out the liquid stored in the liquid storage part 13, and can have at least suction ports 4 (a first suction port 5 and a second suction port 6).

The liquid suction part 11 has the connection surface (M) as shown in FIG. 5B. The liquid suction part 11 has the second portion U at the end opposite to the connection surface (M). The shapes of the connection surface (M) and the second portion U viewed from the +Y direction may be the same shape.

As described above and as shown in FIG. 1B, the liquid suction part 11 of the liquid supply unit part 12 is sandwiched between the first face (P) and the second face (Q) in the region R (seal portion), and is bonded to the liquid storage part 13 near the connection surface (M). Further, the liquid suction part 11 has the second portion U, which is the terminal end of the liquid suction part 11. The connection surface (M) has two slopes (W) sandwiched between the first face (P) and the second face (Q) as shown in FIG. 5B. These slopes (W) are two slopes (W): a slope including a fifth slope and a sixth slope (on the side of the first face (P)) and a slope including a seventh slope and an eighth slope (on the side of the second face (Q)). Specifically, as shown in FIG. 5B, the two slopes (W) are two slopes (W): a slope (the fifth slope and the sixth slope) inclined in opposite directions to each other on the side of the first face (P) and a slope (the seventh slope and the eighth slope) inclined in opposite directions to each other on the side of the second face (Q). In the liquid suction part 11 of the present embodiment, at least one of the angle formed by the fifth slope and the seventh slope and the angle formed by the sixth slope and the eighth slope is an angle B. In the present embodiment, the angle formed by the fifth slope and the seventh slope can be the angle B and the angle formed by the sixth slope and the eighth slope can be also the angle B.

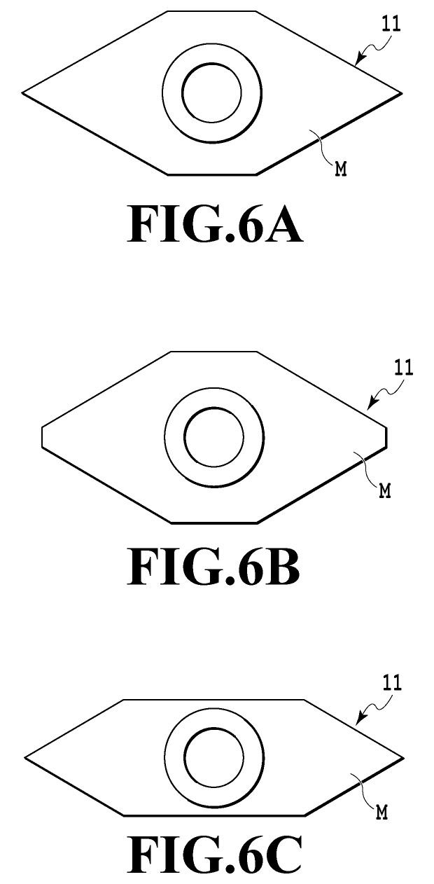

In the present embodiment, the connection surface can have a hexagonal shape as shown in FIG. 5B, but is not limited to this shape. For example, the shapes shown in FIGS. 6A to 6C can be taken as examples of the shape of the connection surface (M). As shown in FIGS. 6A to 6C, the shape of the connection surface (M) may have sharp shapes or chamfered shapes at both ends (both ends in the X-axis direction). Further, the upper and lower sides of the hexagonal shape may be long or short as shown in FIGS. 6A to 6C. In the present embodiment, the angle between the two slopes (W) is denoted by the angle B. As shown in FIG. 5B, the angle B is the angle corresponding to the angle θ at the intersection of extended lines of the fifth and seventh slopes and the angle θ' at the intersection of extended lines of the sixth and eighth slopes. In the present embodiment, the above two slopes (W) may be symmetrical to each other with respect to the plane perpendicular to the gravity direction (the X-Y plane or the central axis plane), as shown in FIG. 5B.

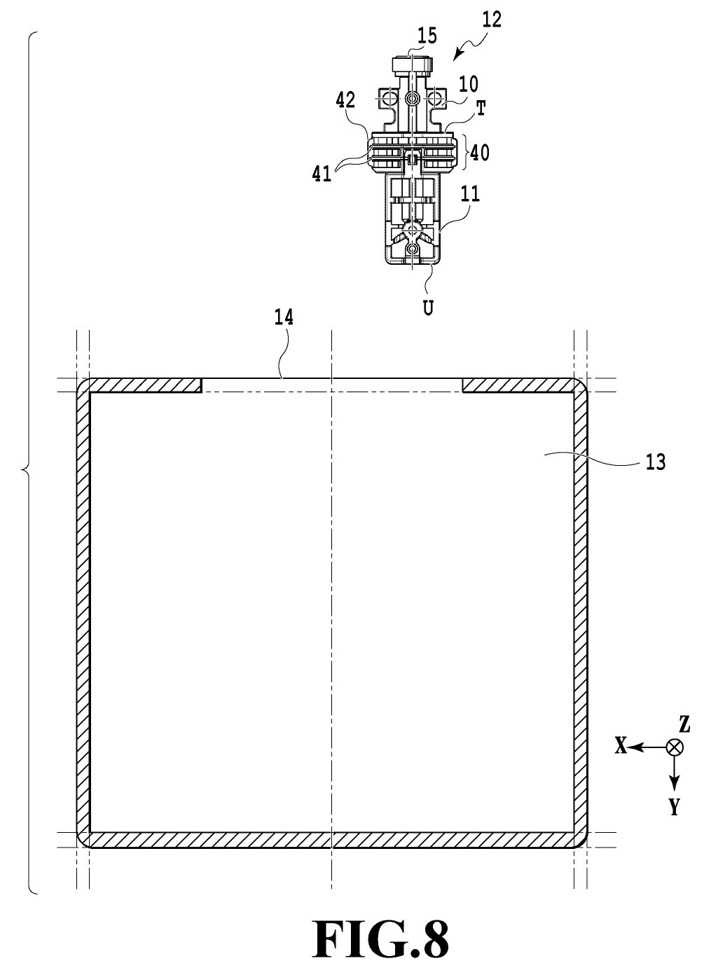

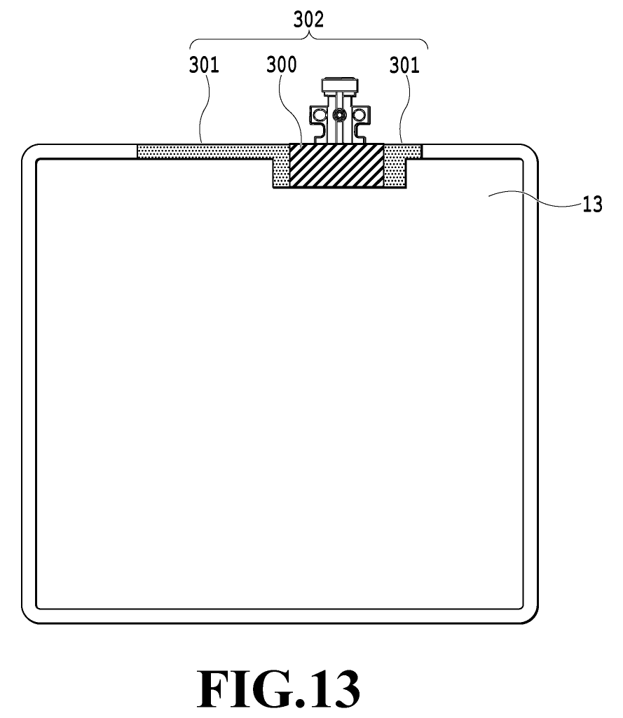

In the present embodiment, as the relationship between the angle A and the angle B described above, the ratio of the angle B to the angle A (the angle ratio B/A) can be 0.8 or more and 1.1 or less, and may be 0.9 or more and 1.1 or less. The reason for such a relationship between the angle A and the angle B is as follows. This is because welding wrinkles may occur in the case where the liquid supply unit part 12 is bonded to the liquid storage part 13 if the ratio of the angle B to the angle A is less than 0.8 or greater than 1.1. For example, consider a case where a first welding portion 300 (see FIG. 13) is welded and then a second welding portion 301 (see FIG. 13) is welded. If the angle A is smaller than the angle B (the angle A < the angle B) at the time of welding this first welding portion 300 and the angle B is within the above range with respect to the angle A (the ratio of the angle B to the angle A is less than 0.8 or greater than 1.1) in welding the liquid supply unit part 12 to the liquid storage part 13, a large height difference occurs in the bonding part. In this case, after the first welding portion 300 is welded (see FIG. 13), the portion of an opening 14 of the liquid storage part 13 (see FIG. 8) is pulled toward the two slopes (V), causing wave-shaped deflection in the first welding portion 300. If the second welding portion 301 is welded in this state, welding wrinkles may occur. In the present embodiment, the angle A between the slopes (V) is set to 60 degrees, and the angle B between the slopes (W) is set to 60 degrees. However, any desired angle may be used as long as the relationship between the angle A and the angle B is within the range described above (the angle B is 0.8 or more and 1.1 or less with respect to the angle A). In one embodiment, the angle A can be in a range of 60±1 degrees, and the angle B can be in a range from 60-2 degrees to 60+1 degrees. However, the angle A and the angle B are desirably such that the magnitude of inclination of the third and fourth slopes (W) does not exceed the magnitude of inclination of the above two slopes (V). Note that the second portion U can have the same shape as the above connection surface (M) and have the same slopes as the two slopes (W). Therefore, the above relationship of the angle ratio between the angle A and the angle B may be the same between the connection surface (M) and the second portion U. Further, if the outline shapes of the liquid supply part 10 and the liquid suction part 11 are different from each other in the liquid supply unit part 12, the outline shape of the liquid suction part 11 can fall within the range of the outline shape of the liquid supply part 10, if these are viewed from the +Y direction.

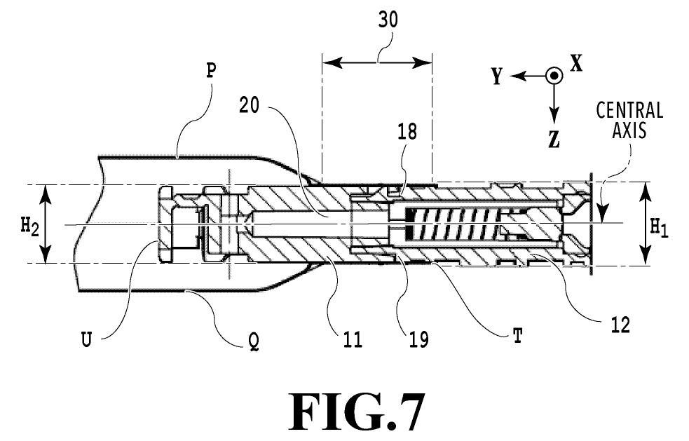

Next, the relationship of height in the gravity direction (the Z-axis direction in FIG. 7) between the liquid supply part 10 and the liquid suction part 11 will be described with reference to FIG. 7.

In the present embodiment, as shown in FIG. 7, the members constituting the liquid supply part 10 do not have height difference, and can have the same height from the central axis toward the upper side and the lower side (in the Z-axis direction). The widths of the members can be also the same in the side face direction (X-axis direction) of the liquid supply part 10. Further, the members constituting the liquid suction part 11 also do not have height difference, and have the same height from the central axis toward the upper side and the lower side (in the Z-axis direction). The widths of the members can be also the same in the side face direction (X-axis direction) of the liquid suction part 11. Furthermore, the height (maximum height) (H₁) of the liquid supply part 10 in the gravity direction shown in FIG. 7 can be equal to the height (maximum height) (H₂) of the liquid suction part 11 in the gravity direction.

In the present embodiment, the height (maximum height) (H₁) of the liquid supply part 10 of the present embodiment in the gravity direction may be -0.2 mm or more and +1.0 mm or less with respect to the liquid suction part 11 (i.e., H₁ is a height within a range from -0.2 mm or more and +1.0 mm or less with respect to H₂). To give a more specific example, if the portion with the maximum height in the gravity direction in the liquid supply part 10 is in the bonding part 40, the height of a first bonding surface 18 and a second bonding surface 19 shown in FIG. 1B in the gravity direction (Z-axis direction) in the plan view of FIG. 1A can be the same as the maximum height of the liquid suction part 11. However, the height between the first bonding surface 18 and the second bonding surface 19 may be -0.2 mm or more and +1.0 mm or less with respect to the liquid suction part 11. If the first bonding surface 18 and the second bonding surface 19 exceed this range and are lower than the liquid suction part 11, the bonding becomes difficult. In other words, if the first bonding surface 18 and the second bonding surface 19 are lower than the liquid suction part 11, stress is generated in the direction in which the seal portion (region R) of the liquid storage part 13 peels from the bonding part 40, and the reliability of bonding can be impaired.

In the present embodiment, the height (maximum height) of the liquid suction part 11 of the present embodiment in the gravity direction may be -1.0 mm or more and +0.2 mm or less with respect to the liquid supply part 10 (i.e., H₂ is a height within a range from -1.0 mm or more and +0.2 mm or less with respect to H₁). If the maximum height of the liquid supply part 10 in the gravity direction is greater than that of the liquid suction part 11 (e.g., there is a height difference of +0.5 mm or more), this increases the space that cannot contract with the consumption of liquid, and thus the ease of using up the liquid or the deaeration state in the liquid storage part 13 becomes unstable.

The following will describe individual constituent elements of each of the liquid supply part 10 and the liquid suction part 11.

### 2-1 Liquid Supply Part

The liquid supply part 10 of the liquid supply unit part 12 has the liquid supply port 15 directed toward the outside of the liquid storage part 13 (the -Y direction in FIG. 1A). The liquid supply port 15 may have any shape as long as it can supply liquid by inserting therein a liquid supply port nozzle provided in the liquid ejection apparatus. Although the shape of the liquid supply port 15 is not particularly limited, it can be a circular shape (including an elliptical shape). A square or polygonal shape can also be employed as the shape of the liquid supply port 15. In this case, it is desirable to match the shape of the liquid supply port nozzle and the shape of the liquid supply port 15 with each other. This is to reduce the risk of leakage of liquid, if the liquid supply port nozzle is inserted into the liquid supply port by matching the shapes of the liquid supply port nozzle and the liquid supply port 15 with each other.

The liquid supply part 10 of the liquid supply unit part 12 of the present disclosure will be described with reference to FIGS. 1A to 3B. As shown in FIG. 1B, after the components are mounted, the liquid supply part 10 is airtightly bonded to the liquid storage part 13 by bonding means such as thermocompression bonding. A portion shown as the liquid supply part 10 in FIG. 3A is provided with the bonding part 40 to be bonded to the liquid storage part 13. The bonding is done by welding, such as thermocompression bonding. As shown in FIG. 3A, the bonding part 40 has bonding ribs 41 that protrude from the bonding surface (protrude in the Z-axis direction) and are actively melted during welding such as thermocompression bonding. Further, the bonding part 40 additionally has welding blades 42 at its ends (in the X-axis direction in the figure). The welding blades 42 can be melted by welding or the like to fill the level difference from the liquid storage part 13. Specifically, in the case where the liquid storage part 13 and the bonding part 40 are bonded together, gaps are created in the region R (seal portion) between the liquid storage part 13 at the ends of the bonding part 40 (the ends of the bonding part 40 in the X-axis direction) and the ends. The welding blades 42 can be melted by welding to fill these gaps. This allows the liquid supply part 10 to ensure high airtightness in the bonding part 40 to the liquid storage part 13. Here, the liquid supply part 10 can be made of a material that can be a molded part, and the material has liquid contact property and is excellent in bondability (in particular, weldability) and moldability. For example, olefin resins, such as polyethylene and polypropylene, are desirable.

As shown in FIGS. 1B and 2, the liquid supply part 10 can include a compression spring 1, a valve 2, and a joint seal (seal member) 3 in a liquid flow hole on the side of the liquid supply port 15. Similar to the above, these members can have liquid contact property and are excellent in bondability (in particular, weldability) and moldability. The material of the compression spring 1can be stainless steel. The valve 2 can be made of an olefin resin, such as polyethylene or polypropylene, and can be a molded part. The joint seal (seal member) 3 is also desirably made of a rubber material (elastomer) or thermoplastic elastomer in terms of liquid contact property with liquid (e.g., ink) and corrosion resistance. For example, elastomer materials can include ethylene propylene diene monomer rubber (EPDM) and hydrogenated nitrile butadiene rubber (H-NBR).

The valve 2 is biased by the compression spring 1 to abut on the joint seal 3 at all times. The joint seal 3 is fixed to the liquid flow hole of the liquid supply part 10 using known means such as rubber lining, bonding, or welding a retainer to the outer periphery. By such fixation of the joint seal 3, the valve 2 is attached so as not to pop out even if biasing force from the compression spring 1 is applied. With this configuration, if force for moving the compression spring 1 in the +Y direction acts on the valve 2, the flow path of the liquid (ink W) is opened. On the other hand, if force for moving it in the -Y direction acts on the valve 2, the flow path of the liquid (ink) is closed, which can prevent inflow of air into the liquid storage part 13 and leakage of liquid (ink). Here, to further reduce the risk of inflow of air and unexpected leakage or backflow of liquid, a configuration can be added to prevent inflow of liquid from the outside of the liquid storage container 50 to the inside of the liquid storage part 13. For example, a configuration can be added to further provide a check valve to the liquid flow hole on the side of the liquid storage part 13 in addition to the valve 2. Further, for the purpose of improving the gas barrier property before attaching the liquid storage container 50, preventing contamination by foreign matters from the outside, and the like, the following configuration may be employed. It is possible to employ a configuration in which another member such as a film (e.g., a mouth film) is welded to the mouth of the liquid flow hole, and in the case where the liquid storage container is attached to the liquid ejection apparatus, an ink needle or the like breaks through the film.

### 2-2 Liquid Suction Part

If the liquid storage container 50 is left unattended, the concentration of liquid may become non-uniform in the liquid storage part. In such cases, if highly concentrated liquid is supplied to the liquid ejection apparatus, for example, the ejection stability can decrease. For this reason, it is desirable to configure the liquid storage container 50 of the present disclosure to suppress the increase in the concentration of liquid near the liquid suction part 11.

The liquid suction part 11 includes at least the configuration as shown in FIG. 5A. That is, the liquid suction part 11 includes the liquid suction ports 4 that are opened so as to be able to suck liquid from the inside of the liquid storage part 13. Further, as shown in FIG. 5A, the liquid suction ports 4 are provided in the gravity direction (Z-axis direction).

According to the above configuration, if the precipitation component in the liquid (ink) inside the liquid storage part 13 has precipitated, the lower concentration portion of the precipitation component of the liquid (ink) (on the -Z-direction side) is sucked from the first liquid suction port 5. Further, the higher concentration portion of the precipitation component (on the +Z direction side) is sucked from the second liquid suction port 6. During these suctions, the lower concentration portion of the precipitation component and the higher concentration portion of the precipitation component are sucked at the same time, and are supplied to the liquid ejection apparatus 100 as liquid (ink) with a uniform concentration. This can suppress variations in the shades of characters, symbols, images, and the like formed on recording sheets due to liquid with extremely high or low concentration being supplied to the liquid ejection apparatus.

The above configuration makes it possible to more actively suck the portion of the liquid that has become difficult to suck due to high concentration or viscosity of the liquid caused by the precipitation of the precipitation component. This enables the concentration of liquid (ink) supplied to a liquid ejection head to be made more uniform.

The liquid suction ports 4 can have a simple round hole shape (circular shape). In addition, in one embodiment, the centers of the first liquid suction port 5 and the second liquid suction port 6 can coincide each other in the case of they are viewed from the Z-axis direction. This simplifies the structure of the flow path of the liquid suction ports 4, making it possible to easily change the opening area A1 of the first liquid suction port 5 and the opening area A2 of the second liquid suction port 6 according to the characteristics of the liquid at the design stage. Therefore, simply changing the opening area A1 and the opening area A2 can greatly change the flow path resistance R1 at the first liquid suction port 5 and the flow path resistance R2 at the second liquid suction port 6. This makes it easier to adjust R1 and R2 according to the liquid. Adjusting R1 and R2 according to the liquid, for example, making R1 higher than R2 makes it possible to more actively suck the portion of the liquid that has become difficult to suck due to high concentration or viscosity of the liquid caused by the precipitation of the precipitation component.

In the present embodiment, anti-asphyxia ribs 7 can be provided around the liquid suction ports 4. If the liquid is sucked and the flexible film constituting the liquid storage part 13 contracts to deform, it may adhere to the liquid supply unit part 12 and close the liquid suction ports 4, thereby interfering with the supply of the liquid. In such cases, the anti-asphyxia ribs 7 can prevent the asphyxiation of the liquid suction ports 4.

As a way to eliminate the above variations in concentration, for example, it can be conceived to provide a mechanism to stir the inside of the liquid storage container, but it is not desirable because the container becomes more complex.

The second portion U of the liquid suction part (an end of the liquid supply unit part to be disposed inside the liquid storage container) can be provided at a position within 60 mm from the side S1 of the liquid storage part 13 in the direction perpendicular to the side S1 (the +Y direction). Furthermore, in one embodiment, the second portion U can be provided at a position within 52 mm in the direction perpendicular to the side S1 (the +Y direction). In one embodiment, the second portion U may be provided at a position within 40 mm.

### II. Liquid Ejection Apparatus

As mentioned above, the liquid storage container 50 according to the present disclosure is set in the liquid ejection apparatus and used. The liquid ejection apparatus may be a commonly used inkjet printer (an inkjet liquid ejection apparatus), or may be a commercial liquid ejection apparatus or an industrial liquid ejection apparatus. In the case where the liquid storage container is an ink pack, its ink capacity can be adjusted flexibly. It is useful to use a liquid storage container (e.g., an ink pack) with a large liquid capacity for a commercial or industrial liquid ejection apparatus that is intended for mass printing or mass recording.

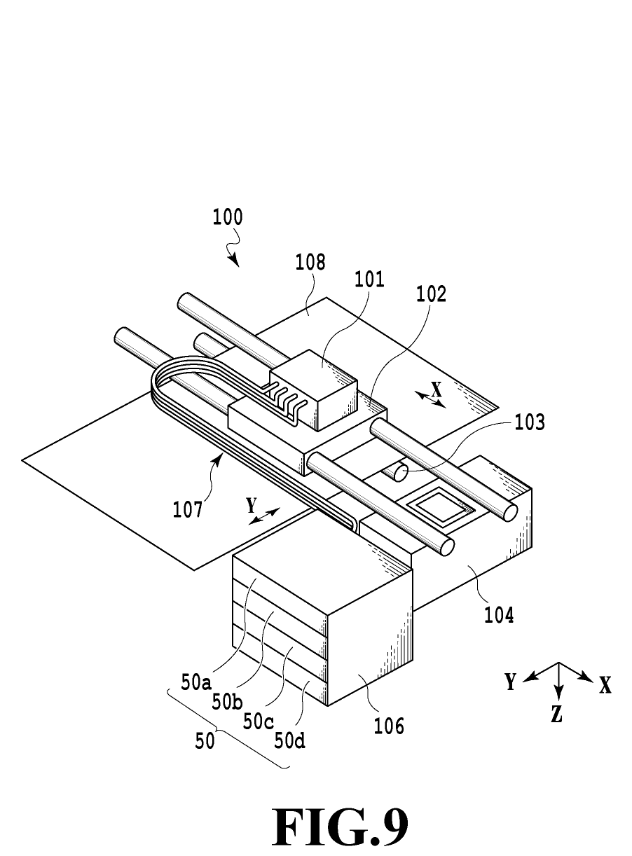

In this specification, as shown in FIG. 9, the direction in which the liquid storage container 50 is attached to and detached from the liquid delivery unit 106 is set to the Y-axis direction. The side of the liquid storage container 50 attached to the liquid delivery unit 106 is in the -Y direction. The width direction of the liquid storage container 50 is set to the X-axis direction.

FIG. 9 is a perspective view showing a schematic configuration of the liquid ejection apparatus 100 according to the first embodiment of the present disclosure. The liquid ejection apparatus 100 shown in FIG. 9 repeats the reciprocal movement of a liquid ejection head 101 (in the main scanning direction (X-axis direction)) and the feeding of a recording sheet 108, which is a recording medium, by a predetermined pitch (in the sub-scanning direction (Y-axis direction)). The liquid ejection apparatus 100 of the present embodiment selectively ejects liquids of a plurality of colors from the liquid ejection head 101 in synchronization with the above movement to cause them to land on the recording sheet 108, which is a recording medium, thereby forming characters, symbols, images, and the like. Note that any recording medium can be used as the recording medium as long as an image and the like can be formed by causing droplets of liquid to land thereon. For example, various materials and forms such as paper, cloth, optical disc label surfaces, plastic sheets, OHP sheets, and envelopes can be used as the recording medium.

The liquid ejection head 101 is detachably mounted on a carriage 102 that is supported by two guide rails in a free-to-slide manner, and is reciprocally moved in a straight line along the guide rails by driving means such as a motor not shown. The recording sheet 108 that receives liquid ejected from a liquid ejection part of the liquid ejection head 101 faces a liquid ejection surface of the liquid ejection head 101, and is fed by a feed roller 103, which is feeding means, in the direction intersecting the movement direction of the carriage 102. The liquid ejection head 101 has a plurality of nozzle rows for ejecting liquids of different colors as a plurality of liquid ejection parts. A plurality of independent liquid storage containers 50 each having the liquid supply port 15 that correspond to the colors of liquids ejected from the liquid ejection head 101 are detachably attached to the liquid delivery unit 106. The liquid delivery unit 106 and the liquid ejection head 101 are connected together via a plurality of liquid supply tubes 107 corresponding to the respective liquid colors. Attaching the liquid storage containers 50 to the liquid delivery unit 106 makes it possible to independently supply liquids of the respective colors stored in the liquid storage containers 50 to the respective nozzle rows of the liquid ejection head 101. In a non-printing area, which is within the range of reciprocal movement of the liquid ejection head 101 and outside the passage range of the recording sheet 108, a recovery unit 104 is disposed to face the liquid ejection surface of the liquid ejection head 101. The recovery unit 104 has a cap part for capping the liquid ejection surface of the liquid ejection head 101, a suction mechanism for forcibly sucking liquid with the liquid ejection surface capped, a cleaning blade for wiping dirt off the liquid ejection surface, and the like. The aforementioned suction operation is performed by this recovery unit 104 prior to recording operations performed by this liquid ejection apparatus. Thereby, even if this liquid ejection apparatus is operated after being left unused for a long period of time, a recovery process performed by the recovery unit 104 can remove residual bubbles in the ejection part of the liquid ejection head 101 and thickened liquid near the ejection ports. This keeps the ejection characteristics of the liquid ejection head 101.

### III. Manufacturing Method of Liquid Storage Container 50

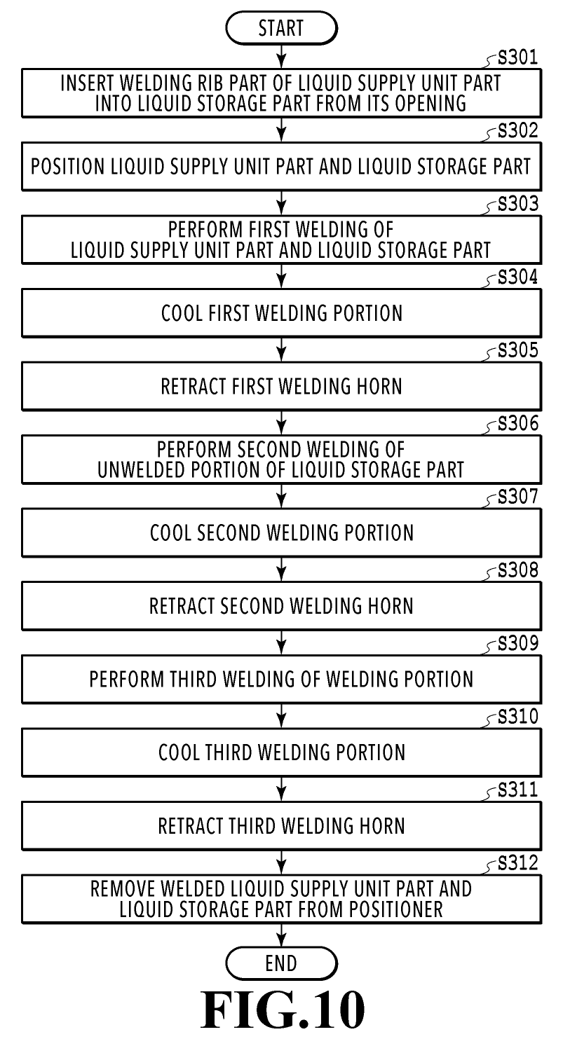

The following will describe a manufacturing method of the liquid storage container of the present disclosure with reference to FIGS. 10 to 13. The liquid storage container of the present disclosure is manufactured using a manufacturing method including the following steps. Note that in the following description, the configuration shown in the drawings of the liquid storage container 50 of the present disclosure described earlier will be referred to as necessary. Further, the following description of the manufacturing method will describe by way of example a case where the region of the bonding part 40 of the liquid supply part 10 and the region of the liquid suction part 11 adjacent to the bonding part 40 (both regions correspond to a bonding portion 30 in FIG. 7) are welded to the liquid storage part 13 by thermocompression bonding. Note that the welding in this manufacturing method is performed in the seal portion (region R) of the above liquid storage container 50, and the seal portion (region R) corresponds to the above bonding portion 30. For example, the welding can be performed on the bonding part 40 of the liquid supply part 10 and the region of the liquid suction part 11 adjacent thereto (the bonding portion 30 in FIG. 7), as shown in FIGS. 1B and 7. However, in the welding of the liquid storage part 13 and the liquid supply unit part 12, the liquid supply part 10 and the liquid suction part 11 may be welded to the seal portion (region R) at any position from the liquid supply port 15 of the liquid supply part 10 to the terminal end (U) of the liquid suction part 11.

The manufacturing method of the liquid storage container 50 of the present disclosure includes a welding step of welding the liquid supply unit part 12 to the liquid storage part 13 of the liquid storage container 50 of the present disclosure. This welding step includes a first welding step and a second welding step for welding the liquid supply unit part 12 to the liquid storage part 13. In the manufacturing method of the present disclosure, the first welding step includes inserting the liquid supply unit part 12 into the opening 14 of the liquid storage part 13 and welding the liquid storage part 13 and the liquid supply unit part 12 together. Further, the second welding step includes welding the unwelded portion of the opening 14 of the liquid storage part 13. The manufacturing method of the liquid storage container 50 of the present disclosure may further include a third welding step as an optional step.

Each welding step will be described below. FIG. 10 is a flowchart showing a manufacturing method of the liquid storage container 50 (see, e.g., FIG. 1A) that can be applied to the present embodiment. Note that the symbol "S" in the description of each step means a step in the flowchart.

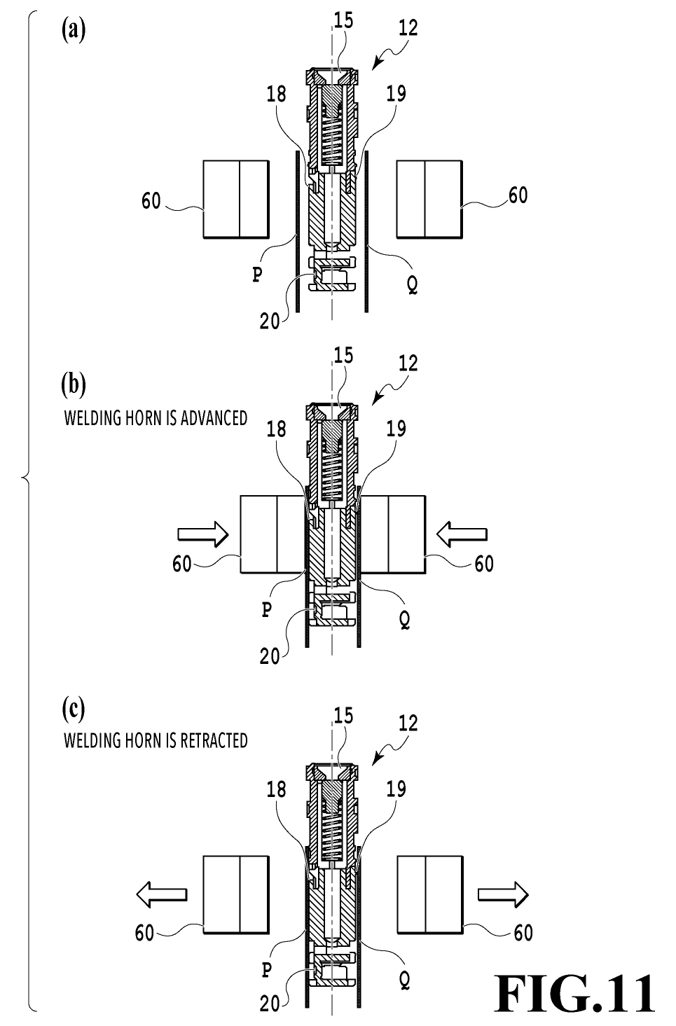

The first welding step is shown in S301 to S305. First, as shown in S301, the opening 14 (see FIG. 8) of the liquid storage part 13 (see, e.g., FIG. 8) is opened, and the liquid supply unit part 12 (see, e.g., FIG. 3A) is inserted therein from the opening 14 of the liquid storage part. The opening 14 corresponds to the region R (seal portion) shown in FIG. 1A. Next, as shown in S302, the positioning of the liquid storage part 13 into which the liquid supply unit part 12 is inserted and a welding apparatus is performed (see FIG. 11A). The positioning is performed at the first welding portion 300 shown in FIG. 13 in the above opening 14 containing the liquid supply unit part 12. The first welding portion 300 can be adapted to the shape of the liquid supply unit part 12 (in particular, the shape of the bonding part 40 of the liquid supply part).

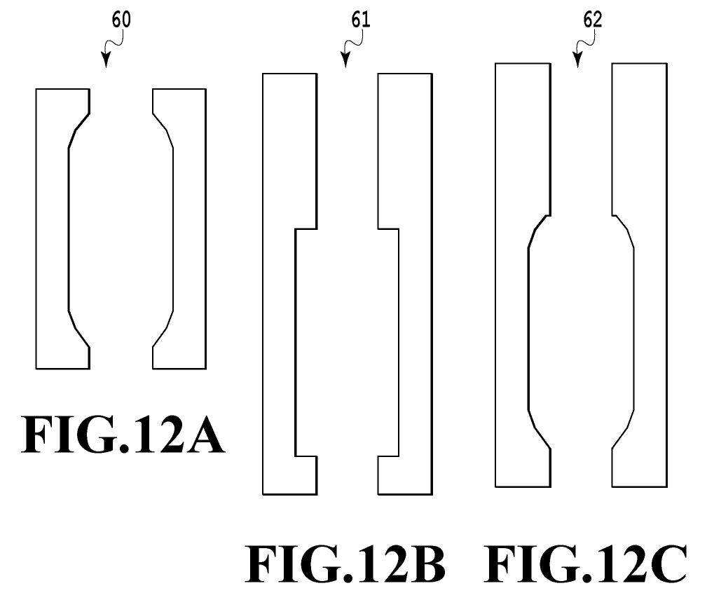

As shown in S303, first welding of the liquid supply unit part 12 and the liquid storage part 13 is performed. In the first welding, the liquid supply unit part 12 is welded in the opening 14 [seal portion (region R)] of the liquid storage part 13 using a first welding horn 60 (FIG. 11B). Specifically, the first welding horn 60 (the shape shown in FIG. 12A) is advanced so as to approach the opening 14 of the liquid storage part 13 and the liquid supply unit part 12. The first welding horn 60 is brought into contact with the liquid storage part 13 and the liquid supply unit part 12 to weld them together. In the first welding step, the first welding portion 300 shown in FIG. 13 in the opening 14 is welded. Note that in the present embodiment, the first welding horn 60 has the shape shown in FIG. 12A, but may be shaped to fit the shape of the first welding portion 300. Further, various conditions such as temperature and pressure during welding can be appropriately selected by those skilled in the art according to the material to be welded.

Then, as shown in S304 to S305 and FIG. 11C, the first welding portion 300 is cooled and the first welding horn is retracted.

S306 to S308 show the second welding step. In these steps, the first face (P) and the second face (Q) of the liquid storage container 50 are welded to the unwelded portion of the opening 14 of the liquid storage part 13 (the second welding portion 301) using a second welding horn 61. Specifically, as shown in FIGS. 11A to 11C, the unwelded portion of the opening 14 of the liquid storage part 13 is welded to the liquid supply unit part 12 using the second welding horn 61 shown in FIG. 12B. In the second welding step, the second welding portion 301 shown in FIG. 13 is welded. Note that in the second welding step, thermocompression bonding is performed on both the first welding portion 300 and the second welding portion 301. Further, in the present embodiment, the second welding horn 61 has the shape shown in FIG. 12B, but may be shaped to fit the shapes of the first welding portion 300 and the second welding portion 301. Further, various conditions such as temperature and pressure during welding can be appropriately selected by those skilled in the art according to the material to be welded.

The occurrence of wrinkles in the welding portion if the step of S304 is performed will be discussed. For example, it is discussed that a case where the angle B between the two slopes (W) of the liquid suction part 11 is greater than the angle A between the two slopes (V) of the bonding part 40 of the liquid supply unit part 12 (the angle ratio: the angle B > the angle A). In other words, it is a case where the angle B and the angle A are such that the angle B > the angle A. In the case of such an angle ratio, the first face (P) and the second face (Q) of the liquid storage part 13 are lifted by the slopes (W). This may cause a height difference in the opening 14 between the portion where the bonding part 40 of the liquid supply part 10 is disposed and the portion where the bonding part 40 is not disposed, which may lead to large undulations in the portion of the opening 14. In other words, the first face (P) and the second face (Q) of the opening 14 may be welded in a wavy state, causing wrinkles.

Therefore, in the present embodiment, the angle A between the two slopes (V) of the bonding part 40 of the liquid supply part 10 and the angle B between the two slopes (W) of the liquid suction part 11 can be the same angle, or the angle B is 0.8 or more and 1.1 or less with respect to the angle A. In the present embodiment, the liquid supply unit part 12 can be formed to satisfy the above relationship between the angle A and the angle B. Such a structure can eliminate undulations in the opening 14 of the liquid storage part in the case where the first welding portion 300 is welded, and can prevent the occurrence of welding wrinkles in the case where the second welding portion 301 is welded.

S309 to S311 show the third welding step. In the present embodiment, the third welding step is a step that is performed optionally, and may not be performed depending on the configuration of the liquid storage part 13 to be welded. It may be performed only in the case where the welding may be further performed in addition to the first welding step and the second welding step described above. For example, in the case of performing reinforcement to further strengthen the welding of the first welding portion 300 and the second welding portion 301, the third welding step can be performed. In the third welding step, the first welding portion 300 and the second welding portion 301 (the third welding portion 302 in FIG. 13) are welded using a third welding horn 62 shown in FIG. 12C. The third welding step can be performed in the procedure shown in FIGS. 11A to 11C, in the same procedure as those described above for the first welding portion 300. Note that in the present embodiment, the third welding horn 62 has the shape shown in FIG. 12C, but is desirably shaped to fit the shape of the third welding portion 302.

At last, as shown in S312, the liquid storage container 50 to which the first welding portion 300, the second welding portion 301, and the third welding portion 302 are welded is removed from the positioner of the welding apparatus.

The liquid storage container 50 of the present embodiment is completed through the above steps. After that, filling the liquid storage container 50 with predetermined liquid (e.g., ink) from the liquid supply port 15 results in a liquid storage container (an ink pack) that can be used in the liquid ejection apparatus.

As described above, in the present embodiment, the slopes (V) of the bonding part 40 of the liquid supply part and the slopes (W) of the connection surface (M) of the liquid suction part 11 are formed to have the same inclination, thereby enabling elimination of undulations in the opening 14 of the liquid storage part in the case where the first welding portion is welded. This enables prevention of occurrence of bonding wrinkles in the case where the second welding portion is bonded.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide a liquid storage container that reduces uncontracted space if the liquid storage container contracts, and prevents welding wrinkles in a liquid storage part due to welding. Further, according to the present disclosure, it is possible to provide a manufacturing method of the liquid storage container and a liquid ejection apparatus using the liquid storage container.

This application claims the benefit of priority from Japanese Patent Application No. 2025-025885, filed February 20, 2025, which is hereby incorporated by reference herein in its entirety.

What is claimed is:

1. A liquid storage container comprising a liquid storage part that stores liquid and a liquid supply unit part that is attached to the liquid storage part, wherein
the liquid storage part has a first face and a second face,
the liquid supply unit part comprises a liquid suction part and a liquid supply part,
the liquid supply part has a first slope and a second slope inclined in opposite directions to each other on a side of the first face and a third slope and a fourth slope inclined in opposite directions to each other on a side of the second face, and at least one of an angle formed by the first slope and the third slope and an angle formed by the second slope and the fourth slope is an angle A,
the liquid suction part has a fifth slope and a sixth slope inclined in opposite directions to each other on the side of the first face and a seventh slope and an eighth slope inclined in opposite directions to each other on the side of the second face, and at least one of an angle formed by the fifth slope and the seventh slope and an angle formed by the sixth slope and the eighth slope is an angle B, and
an angle ratio (B/A) of the angle B to the angle A is greater than or equal to 0.8 and less than or equal to 1.1.

2. The liquid storage container according to claim 1, wherein the liquid supply part and the liquid suction part are connected together to have a common central axis in a longitudinal direction, the liquid supply part has a maximum height H₁ in a gravity direction orthogonal to the longitudinal direction in the case where the liquid supply part is viewed from the longitudinal direction, the liquid suction part has a maximum height H₂ in the gravity direction orthogonal to the longitudinal direction in the case where the liquid suction part is viewed from the longitudinal direction, and H₁ has a height within a range greater than or equal to -0.2 mm and less than or equal to +1.0 mm with respect to H₂.

3. The liquid storage container according to claim 2, wherein the liquid supply part has a bonding part at a position where the liquid supply part is joined to the liquid storage part as the liquid supply unit part, the maximum height H₁ is a height of the bonding part, and the maximum height H₂ is a height of a terminal end of the liquid suction part.

4. The liquid storage container according to claim 1, wherein the liquid supply part and the liquid suction part are connected together to have a common central axis in a longitudinal direction, the liquid suction part has a maximum height H₂ in a gravity direction orthogonal to the longitudinal direction if the liquid suction part is viewed from the longitudinal direction, the liquid supply part has a maximum height H₁ in the gravity direction orthogonal to the longitudinal direction if the liquid supply part is viewed from the longitudinal direction, and H₂ has a height within a range greater than or equal to -1.0 mm and less than or equal to +0.2 mm with respect to H₁.

5. The liquid storage container according to claim 4, wherein the liquid supply part has a bonding part at a position where the liquid supply part is joined to the liquid storage part as the liquid supply unit part, the maximum height H₁ is a height of the bonding part, and the maximum height H₂ is a height of a terminal end of the liquid suction part.

6. The liquid storage container according to claim 1, wherein the liquid supply part and the liquid suction part have a common central axis in a longitudinal direction, and have the same height in a gravity direction perpendicular to the central axis if they are viewed from a direction of the central axis.

7. A manufacturing method of a liquid storage container, wherein
the liquid storage container comprises a liquid storage part that stores liquid and a liquid supply unit part that is attached to the liquid storage part,
the liquid storage part has a first face and a second face,
the liquid supply unit part comprises a liquid suction part and a liquid supply part,
the liquid supply part has a first slope and a second slope inclined in opposite directions to each other on a side of the first face and a third slope and a fourth slope inclined in opposite directions to each other on a side of the second face, and at least one of an angle formed by the first slope and the third slope and an angle formed by the second slope and the fourth slope is an angle A,
the liquid suction part has a fifth slope and a sixth slope inclined in opposite directions to each other on the side of the first face and a seventh slope and an eighth slope inclined in opposite directions to each other on the side of the second face, and at least one of an angle formed by the fifth slope and the seventh slope and an angle formed by the sixth slope and the eighth slope is an angle B, and
an angle ratio (B/A) of the angle B to the angle A is greater than or equal to 0.8 and less than or equal to 1.1, and
the manufacturing method comprises
a first welding step and a second welding step for welding the liquid supply unit part to the liquid storage part,
the first welding step comprises a step of inserting the liquid supply unit part into an opening of the liquid storage part, and welding the liquid storage part and the liquid supply unit part together, and
the second welding step comprises a step of welding an unwelded portion of the opening of the liquid storage part.

8. The manufacturing method according to claim 7, further comprising a third welding step of further welding a portion welded in the first welding step and a portion welded in the second welding step.

9. A liquid ejection apparatus comprising a liquid ejection head and a liquid delivery unit that delivers liquid to the liquid ejection head, the liquid delivery unit comprising
a liquid storage container comprising a liquid storage part that stores liquid and a liquid supply unit part that is attached to the liquid storage part, wherein
the liquid storage part has a first face and a second face,
the liquid supply unit part comprises a liquid suction part and a liquid supply part,
the liquid supply part has a first slope and a second slope inclined in opposite directions to each other on a side of the first face and a third slope and a fourth slope inclined in opposite directions to each other on a side of the second face, and at least one of an angle formed by the first slope and the third slope and an angle formed by the second slope and the fourth slope is an angle A,
the liquid suction part has a fifth slope and a sixth slope inclined in opposite directions to each other on the side of the first face and a seventh slope and an eighth slope inclined in opposite directions to each other on the side of the second face, and at least one of an angle formed by the fifth slope and the seventh slope and an angle formed by the sixth slope and the eighth slope is an angle B, and
an angle ratio (B/A) of the angle B to the angle A is greater than or equal to 0.8 and less than or equal to 1.1.
